(19) United States
(12) Patent Application Publication
(10) Pub. No.: US 2020/0133951 A1
(43) Pub. Date: Apr. 30, 2020

(54) SYSTEMS AND METHODS FOR DATA STORAGE AND DATA QUERY

(71) Applicant: BEIJING DIDI INFINITY TECHNOLOGY AND DEVELOPMENT CO., LTD., Beijing (CN)

(72) Inventors: Shunda WANG, Beijing (CN); Pei LI, Beijing (CN); Fan YANG, Beijing (CN)

(73) Assignee: BEIJING DIDI INFINITY TECHNOLOGY AND DEVELOPMENT CO., LTD., Beijing (CN)

(21) Appl. No.: 16/726,870

(22) Filed: Dec. 25, 2019

Related U.S. Application Data
(63) Continuation of application No. PCT/CN2018/092755, filed on Jun. 26, 2018.

(30) Foreign Application Priority Data
Jun. 26, 2017 (CN) 201710492917.1

(51) Int. Cl. G06F 16/2458; G06F 16/2453; G06F 16/22; G06F 16/28

(52) U.S. Cl. CPC G06F 16/2477; G06F 16/24539; G06F 16/285; G06F 16/221; G06F 16/2282

(57) ABSTRACT

The present disclosure is related to systems and methods for storing data and querying data. The method includes dividing an area into a plurality of sub-areas. For each sub-area of the plurality of sub-areas, the method also includes dividing a time period associated with historical data of the each sub-area into a plurality of unit time periods, wherein the historical data satisfy an interval subtraction rule. The method further includes determining a relationship between each unit time period and a sum of historical data up to each unit time period. The method still further includes storing a plurality of sums associated with the plurality of unit time periods into a storage space in a chronological order.

### CROSS-REFERENCE TO RELATED APPLICATIONS

This application is a continuation of International Application No. PCT/CN2018/092755, filed on Jun. 26, 2018, which claims priority of Chinese Patent Application No. 201710492917.1 filed on Jun. 26, 2017, the entire contents of each of which are hereby incorporated by reference.

### TECHNICAL FIELD

This disclosure generally relates to data technology, and more particularly, relates to systems and methods for data storage and data query.

### BACKGROUND

Data storage systems and data query systems are widely used in various fields, such as online to offline services (e.g., a taxi hailing service, a delivery service, and an online shopping service). Data storage systems may store data related to services. Data query systems may query data based on a query request sent from a user or a terminal. For example, for data related to a taxi hailing service, the query request may be a query for historical data related to a certain type of vehicle in an area in a time period. In some situations, the data query system(s) may need to traverse all historical data related to the certain type of vehicle in the area in the time period. However, traversing all historical data related to the certain type of vehicle in the area in the time period may be time consuming and may cause a poor user experience. Therefore, it is desirable to provide systems and methods for storing data and querying data more efficiently.

### SUMMARY

According to an aspect of the present disclosure, a system of data storage may include at least one storage device including a set of instructions or programs and at least one processor configured to communicate with the at least one storage device. When executing the set of instructions or programs, the at least one processor may be configured to cause the system to divide an area into a plurality of sub-areas. For each sub-area of the plurality of sub-areas, the at least one processor may also cause the system to divide a time period associated with historical data of the each sub-area into a plurality of unit time periods. The historical data may satisfy an interval subtraction rule. The at least one processor may also cause the system to determine a relationship between each unit time period and a sum of historical data up to each unit time period. The at least one processor may further cause the system to store a plurality of sums associated with the plurality of unit time periods into a storage space in a chronological order.

In some embodiments, the at least one processor may also cause the system to determine a sum of historical data from a start time of the time period to each unit time period. The at least one processor may further cause the system to associate the sum of historical data with each unit time period.

In some embodiments, the at least one processor may also cause the system to determine m time dimensions other than a time dimension related to the time period, m being an integer greater than or equal to 0. The at least one processor may further cause the system to determine the m+1 dimensional storage space based on the time dimension related to the time period and the m time dimensions.

In some embodiments, the at least one processor may also cause the system to determine a granularity of the time dimension related to the time period of the m+1 dimensional storage space. The at least one processor may further cause the system to determine m granularities of the m time dimensions of the m+1 dimensional storage space, respectively.

In some embodiments, the storage space may be a key-value database, and primary keys of the key-value database may include the plurality of unit time periods and the m time dimensions.

In some embodiments, the plurality of sub-areas may have a same size.

In some embodiments, each sub-area may have a rectangular shape.

According to another aspect of the present disclosure, a system of data query may include at least one storage device including a set of instructions or programs, an exchange data port communicatively connected to a network, and at least one processor configured to communicate with the at least one storage device. When executing the set of instructions or programs, the at least one processor may be configured to cause the system to receive a query request via the data exchange port. The at least one processor may also cause the system to determine, based on the query request, a target sub-area, a starting time, an ending time. The at least one processor may also cause the system to determine, based on historical data associated with the target sub-area, an initial time, and time dimensions related to the historical data associated with the target sub-area. The at least one processor may also cause the system to determine a first unit time period associated with the ending time. The at least one processor may also cause the system to determine a second unit time period associated with the starting time. The at least one processor may also cause the system to determine a first sum of a first set of historical data from the initial time to a unit time period prior to the first unit time period. The at least one processor may also cause the system to determine a second sum of a second set of historical data from the initial time to a unit time period prior to the second unit time period. The at least one processor may further cause the system to determine a query result based on the first sum, the second sum, and the time dimensions related to the historical data associated with the target sub-area.

In some embodiments, the at least one processor may also cause the system to determine whether at least one of the first sum or the second sum is stored in a cache of the system.

In some embodiments, in response to a determination that the at least one of the first sum or the second sum is stored in the cache, the at least one processor may also cause the system to obtain the at least one of the first sum or the second sum from the cache.

In some embodiments, in response to a determination that the at least one of the first sum or the second sum is not stored in the cache, the at least one processor may also cause the system to obtain the at least one of the first sum or the second sum from a storage space.

In some embodiments, the at least one processor may also cause the system to subtract a second integration of the second sum in all of the time dimensions from a first integration of the first sum in all of the time dimensions. The at least one processor may further cause the system to add a third integration of a third sum of a third set of historical data in all of the time dimensions, the third set of historical data corresponding to one or more unit time periods of which historical data are subtracted repeatedly.

In some embodiments, the at least one processor may also cause the system to receive the query request from a computing terminal via the data exchange port.

In some embodiments, the at least one processor may also cause the system to transmit the query result to the computing terminal via the data exchange port.

According to still another aspect of the present disclosure, a computer-implemented method may include one or more of the following operations performed by at least one processor. The method may include dividing an area into a plurality of sub-areas. For each sub-area of the plurality of sub-areas, the method may also include dividing a time period associated with historical data of the each sub-area into a plurality of unit time periods. The historical data may satisfy an interval subtraction rule. The method may also include determining a relationship between each unit time period and a sum of historical data up to each unit time period. The method may further include storing a plurality of sums associated with the plurality of unit time periods into a storage space in a chronological order.

According to still another aspect of the present disclosure, a computer-implemented method may include one or more of the following operations performed by at least one processor. The method may include receiving a query request via the data exchange port. The method may also include determining, based on the query request, a target sub-area, a starting time, and an ending time. The method may also include determining, based on historical data associated with the target sub-area, an initial time, and time dimensions related to the historical data associated with the target sub-area. The method may also include determining a first unit time period associated with the ending time. The method may also include determining a second unit time period associated with the starting time. The method may also include determining a first sum of a first set of historical data from the initial time to a unit time period prior to the first unit time period. The method may also include determining a second sum of a second set of historical data from the initial time to a unit time period prior to the second unit time period. The method may further include determining a query result based on the first sum, the second sum, and the time dimensions related to the historical data associated with the target sub-area.

According to still another aspect of the present disclosure, a non-transitory computer readable medium may include at least one set of instructions for storing data, wherein when executed by one or more processors of a computing device, the at least one set of instructions may cause the computing device to perform a method. The method may include one or more of the following operations performed by at least one processor. The method may include dividing an area into a plurality of sub-areas. For each sub-area of the plurality of sub-areas, the method may also include dividing a time period associated with historical data of the each sub-area into a plurality of unit time periods. The historical data may satisfy an interval subtraction rule. The method may also include determining a relationship between each unit time period and a sum of historical data up to each unit time period. The method may further include storing a plurality of sums associated with the plurality of unit time periods into a storage space in a chronological order.

According to yet another aspect of the present disclosure, a non-transitory computer readable medium may include at least one set of instructions for querying data, wherein when executed by one or more processors of a computing device, the at least one set of instructions may cause the computing device to perform a method. The method may include one or more of the following operations performed by at least one processor. The method may include receiving a query request via the data exchange port. The method may also include determining, based on the query request, a target sub-area, a starting time, and an ending time. The method may also include determining, based on historical data associated with the target sub-area, an initial time, and time dimensions related to the historical data associated with the target sub-area. The method may also include determining a first unit time period associated with the ending time. The method may also include determining a second unit time period associated with the starting time. The method may also include determining a first sum of a first set of historical data from the initial time to a unit time period prior to the first unit time period. The method may also include determining a second sum of a second set of historical data from the initial time to a unit time period prior to the second unit time period. The method may further include determining a query result based on the first sum, the second sum, and the time dimensions related to the historical data associated with the target sub-area.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary data system according to some embodiments of the present disclosure;

FIG. 2 is a schematic diagram illustrating exemplary components of a computing device according to some embodiments of the present disclosure;

FIG. 3 is a schematic diagram illustrating exemplary hardware and/or software components of an exemplary mobile device according to some embodiments of the present disclosure;

FIG. 4 is a block diagram illustrating an exemplary processing engine according to some embodiments of the present disclosure;

FIG. 5A is a block diagram illustrating an exemplary processing engine according to some embodiments of the present disclosure;

FIG. 5B is a block diagram illustrating an exemplary data obtaining module according to some embodiments of the present disclosure;

FIG. 6 is a flow chart illustrating an exemplary process for storing data into a storage space according to some embodiments of the present disclosure;

FIG. 7 is a flow chart illustrating an exemplary process for storing data into a storage space according to some embodiments of the present disclosure;

FIG. 8A is a schematic diagram illustrating an exemplary one dimensional storage space according to some embodiments of the present disclosure;

FIG. 8B is a schematic diagram illustrating an exemplary two dimensional storage space according to some embodiments of the present disclosure;

FIG. 9 is a flow chart illustrating an exemplary process for storing data into a storage space according to some embodiments of the present disclosure;

FIG. 10 is a flow chart illustrating an exemplary process for querying data according to some embodiments of the present disclosure;

FIG. 11 is a flow chart illustrating an exemplary process for querying data according to some embodiments of the present disclosure; and

FIG. 12 is a schematic diagram illustrating an exemplary process for data query according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

Moreover, the systems and methods in the present disclosure may be applied to any application scenario in which a data storage and query service is required. For example, the system or method of the present disclosure may be applied to different transportation systems including land, ocean, aerospace, or the like, or any combination thereof. The transportation systems may provide transportation service for users using various vehicles. The vehicles of the transportation service may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The system or method of the present disclosure may be applied to a taxi hailing service, a chauffeur service, a delivery service, a carpooling service, a bus service, a take-out service, a driver hiring service, a shuttle service, a travel service, or the like, or any combination thereof. As another example, the system or method of the present disclosure may be applied to a navigation service, a shopping service, a house service, a location based service (LBS), or the like, or any combination thereof. The application scenarios of the system or method of the present disclosure may include a web page, a plug-in of a browser, a client terminal, a custom system, an internal analysis system, an artificial intelligence robot, or the like, or any combination thereof.

An aspect of the present disclosure is directed to systems and methods for storing data. The systems and methods may divide an area into a plurality of sub-areas. For each sub-area of the plurality of sub-areas, the systems and methods may divide a time period associated with historical data of the each sub-area into a plurality of unit time periods. The historical data may be associated with a service (e.g., a taxi hailing service, a carpooling service, a delivery service, an online shopping service) provided in the sub-area. The historical data may satisfy an interval subtraction rule. The systems and methods may also determine a relationship between each unit time period and a sum of historical data up to each unit time period. Accordingly, the systems and methods may store a plurality of sums associated with the plurality of unit time periods into a storage space (e.g., a one dimensional storage space, a two dimensional storage space) in a chronological order.

Another aspect of the present disclosure is directed to systems and methods for querying data in a storage space. The systems and methods may receive a query request from a computing terminal. The systems and methods may determine, based on the query request, a target sub-area, a starting time, an ending time, time dimensions related to the historical data associated with the target sub-area, a first unit time period associated with the ending time, a second unit time period associated with the starting time, a first sum of a first set of historical data from the starting time to a unit time period prior to the first unit time period, a second sum of a second set of historical data from the starting time to a unit time period prior to the second unit time period. Accordingly, the systems and methods may determine a query result based on the first sum, the second sum, and the time dimensions related to the historical data associated with the target sub-area.

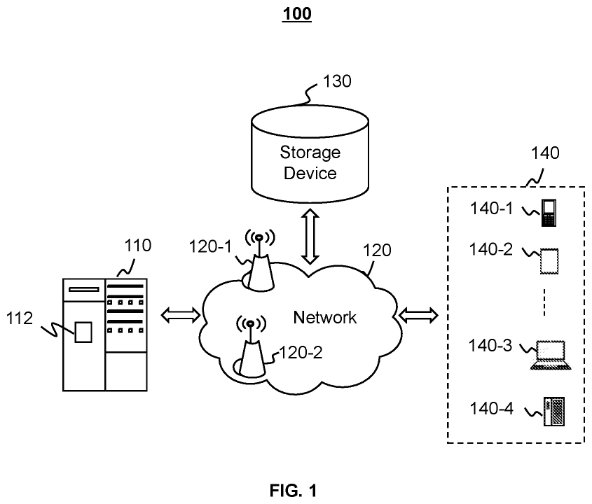

FIG. 1 is a schematic diagram illustrating an exemplary data system according to some embodiments of the present disclosure. The data system 100 may include a server 110, a network 120, a storage device 130, and a computing terminal 140.

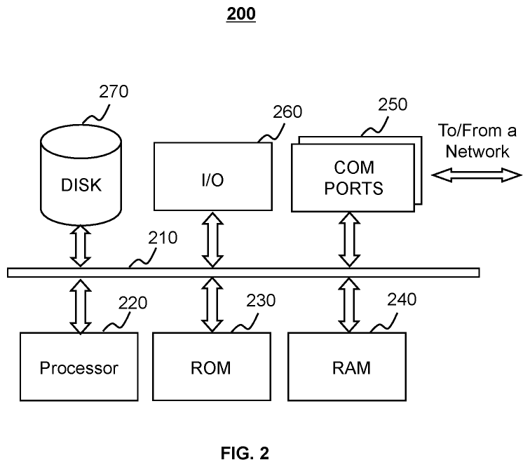

The server 110 may facilitate data processing, data storage, and/or data query for the data system 100. In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the computing terminal 140, and/or the storage device 130 via the network 120. As another example, the server 110 may be directly connected to the computing terminal 140, and/or the storage device 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may divide an area into a plurality of sub-areas. As another example, the processing engine 112 may divide a time period associated with historical data of a sub-area into a plurality of unit time periods. As still another example, the processing engine 112 may determine a relationship between a unit time period and a sum of historical data up to the unit time period. As still another example, the processing engine 112 may determine a storage space and store a plurality of sums associated with a plurality of unit time periods into the storage space in a chronological order. As still another example, the processing engine 112 may receive a query request from a computing terminal. As still another example, the processing engine 112 may determine, based on a query request, a target sub-area, a starting time, an ending time, time dimensions related to the historical data associated with the target sub-area, a first unit time period associated with the ending time, a second unit time period associated with the starting time, a first sum of a first set of historical data from the starting time to a unit time period prior to the first unit time period, a second sum of a second set of historical data from the starting time to a unit time period prior to the second unit time period. As still another example, the processing engine 112 may determine a query result based on a first sum, a second sum, and time dimensions related to historical data associated with a target sub-area.

In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the data system 100 (e.g., the server 110, the storage device 130, and the computing terminal 140) may send information and/or data to other component(s) in the data system 100 via the network 120. For example, the processing engine 112 may receive a query request from the storage device 130 and/or the computing terminal 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the data system 100 may be connected to the network 120 to exchange data and/or information.

The storage device 130 may store data and/or instructions. In some embodiments, the storage device 130 may store data obtained from the computing terminal 140 and/or the processing engine 112. For example, the storage device 130 may store a query request received from the computing terminal 140. As another example, the storage device 130 may store a relationship between a unit time period and a sum of historical data up to the unit time period determined by the processing engine 112. In some embodiments, the storage device 130 may store data and/or instructions that the server 110 may execute or use to perform exemplary methods described in the present disclosure. For example, the storage device 130 may store instructions that the processing engine 112 may execute or use to divide an area into a plurality of sub-areas. As another example, the storage device 130 may store instructions that the processing engine 112 may execute or use to determine a relationship between a unit time period and a sum of historical data up to the unit time period. As still another example, the storage device 130 may store instructions that the processing engine 112 may execute or use to determine an m+1 dimensional storage space. In some embodiments, the storage device 130 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 120 to communicate with one or more components in the data system 100 (e.g., the server 110, the computing terminal 140, etc.). One or more components in the data system 100 may access the data or instructions stored in the storage device 130 via the network 120. In some embodiments, the storage device 130 may be directly connected to or communicate with one or more components in the data system 100 (e.g., the server 110, the computing terminal 140, etc.). In some embodiments, the storage device 130 may be part of the server 110.

In some embodiments, the computing terminal 140 may include a mobile device 140-1, a tablet computer 140-2, a laptop computer 140-3, or the like, or any combination thereof. In some embodiments, the mobile device 140-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc.

It should be noted that the data system 100 is merely provided for the purposes of illustration, and is not intended to limit the scope of the present disclosure. For persons having ordinary skills in the art, multiple variations or modifications may be made under the teachings of the present disclosure. For example, the data system 100 may further include a database, an information source, or the like. As another example, the data system 100 may be implemented on other devices to realize similar or different functions. However, those variations and modifications do not depart from the scope of the present disclosure.

FIG. 2 is a schematic diagram illustrating exemplary components of a computing device on which the server 110, the storage device 130, and/or the computing terminal 140 may be implemented according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the computing device 200 may implement any component of the data system 100 as described herein. In FIGS. 1-2, only one such computer device is shown purely for convenience purposes. One of ordinary skill in the art would understood at the time of filing of this application that the computer functions relating to data storage and/or data query as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

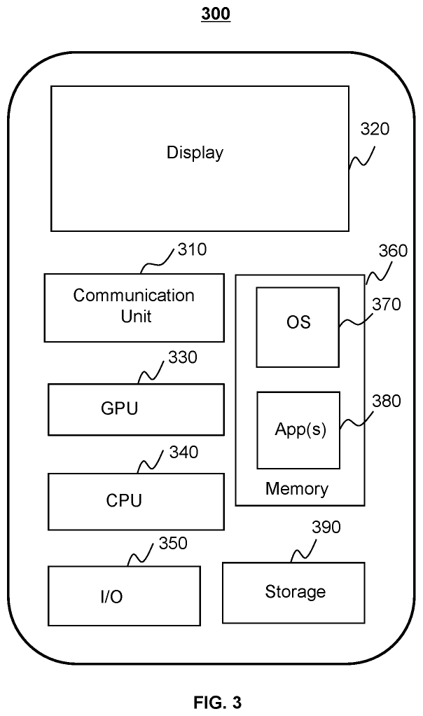

FIG. 3 is a schematic diagram illustrating exemplary hardware and/or software components of an exemplary mobile device according to some embodiments of the present disclosure; on which the computing terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™ Windows Phone™, etc.) and one or more applications 380 may be loaded into the memory 360 from the storage 390 in order to be executed by the CPU 340. The applications 380 may include a browser or any other suitable mobile apps for receiving and rendering information relating to a query request or other information from the data system on the mobile device 300. User interactions with the information stream may be achieved via the I/O devices 350 and provided to the processing engine 112 and/or other components of the data system 100 via the network 120.

In order to implement various modules, units and their functions described above, a computer hardware platform may be used as hardware platforms of one or more elements (e.g., a component of the sever 110 described in FIG. 2). Since these hardware elements, operating systems, and program languages are common, it may be assumed that persons skilled in the art may be familiar with these techniques and they may be able to provide information required in data storage and/or data query according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

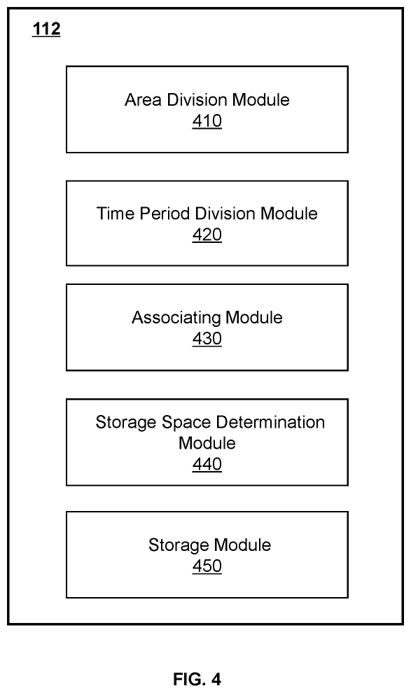

FIG. 4 is a block diagram illustrating an exemplary processing engine according to some embodiments of the present disclosure. In some embodiments, the processing engine 112 may include an area division module 410, a time period division module 420, an associating module 430, a storage space determination module 440, and a storage module 450. The modules may be hardware circuits of at least part of the processing engine 112. The modules may also be implemented as an application or set of instructions read and executed by the processing engine 112. Further, the modules may be any combination of the hardware circuits and the application/instructions. For example, the modules may be the part of the processing engine 112 when the processing engine 112 is executing the application or set of instructions.

In some embodiments, the area division module 410 may divide an area into a plurality of sub-areas. The area to be divided may be a geographical area. In some embodiments, the area may be determined based on the type of data to be stored in the data system 100. In some embodiments, the area division module 410 may divide the area randomly. Additionally and/or alternatively, the area division module 410 may divide the area based on one or more parameters, such as a size of the area, a division of an administrative area (e.g., a country, a province, a city, or a district), longitudinal and latitudinal coordinates, or the like, or any combination thereof. The sub-areas may have any size and/or shape. The shapes and/or sizes of different sub-areas may be the same or different. In some embodiments, the area division module 410 may divide the area into a plurality of sub-areas with the same size and/or the same shape. For example, the area division module 410 may uniformly divide the area into a plurality of sub-areas having a polygonal shape, such as a regular triangle (e.g., an equilateral triangle with a side length of 500 meters), a rectangle (e.g., a rectangle with a length of 500 meters and a width of 300 meters), a square, or a regular hexagon, or the like.

In some embodiments, the time period division module 420 may divide a time period associated with the historical data collected in the each sub-area into a plurality of unit time periods. The historical data may relate to a service provided in the sub-area. Merely for illustration purposes, the service may include a taxi hailing service, a carpooling service, a hitch service, a delivery service, an online shopping service, a medical service, a map-based service, or the like, or any combination thereof. Take the taxi-hailing service as an example, the historical data may include a number (or count) of service orders generated in a sub-area, a number (or count) of service providers positioned in a sub-area, a number (or count) of service requesters positioned in a sub-area, a number (or count) of completed service requests in a sub-area, or the like. In some embodiments, the historical data may satisfy an interval subtraction rule. In some embodiments, the time period associated with the historical data of the each sub-area may be a year, a month, a week, a day, or any time period from a starting time to an ending time.

In some embodiments, the duration of a unit time period (also referred to as a granularity of the unit time period) may be, for example, 0.5 hour, 1 hour, 5 hours, 10 hours, or 24 hours, or the like. In some embodiments, the duration of the unit time period may be set manually or be determined by one or more components of the data system 100 according to different situations. In some embodiments, the time period division module 420 may divide the time period into a plurality of unit time periods based on the duration of a unit time period. In some embodiments, the time period division module 420 may divide the time period into a plurality of unit time periods based on a predetermined number (or count) of the unit time periods. In some embodiments, the number (or count) of the unit time periods may be set according to a default setting of the data system 100 or preset by a user or operator via the computing terminal 140. In some embodiments, the time period division module 420 may uniformly divide the time period into a plurality of unit time periods.

In some embodiments, the associating module 430 may determine a relationship between each unit time period and a sum of historical data up to each unit time period. In some embodiments, the associating module 430 may determine a sum of historical data from a start time of the time period to each unit time period. In some embodiments, the associating module 430 may associate the sum of historical data with each unit time period. For example, the associating module 430 may divide time period associated with historical data of a sub-area into n unit time periods, wherein n may be an integer greater than 1. For an ith unit time period in the n unit time periods, the associating module 430 may determine an ith sum of historical data from the start time of the time period to the ith unit time period, wherein i may be an integer greater than 1 and less than or equal to n. The associating module 430 may associate the ith sum with the ith unit time period.

In some embodiments, the associating module 430 may determine a first relationship between a first unit time period and a first sum of a first set of historical data corresponding to the first unit time period. In some embodiments, the associating module 430 may determine a second relationship between a second unit time period and a second sum of the first set of target historical data and a second set of target historical data, wherein the second set of historical data correspond to the second unit time period. Similarly, the associating module 430 may determine an nth relationship between an nth unit time period and an nth sum from the first set of historical data to an nth set of historical data corresponding to the nth unit time period.

In some embodiments, the storage space determination module 440 may determine an m+1 dimensional storage space based on a time dimension related to the time period and m time dimensions. In some embodiments, m may be an integer greater than or equal to 0.

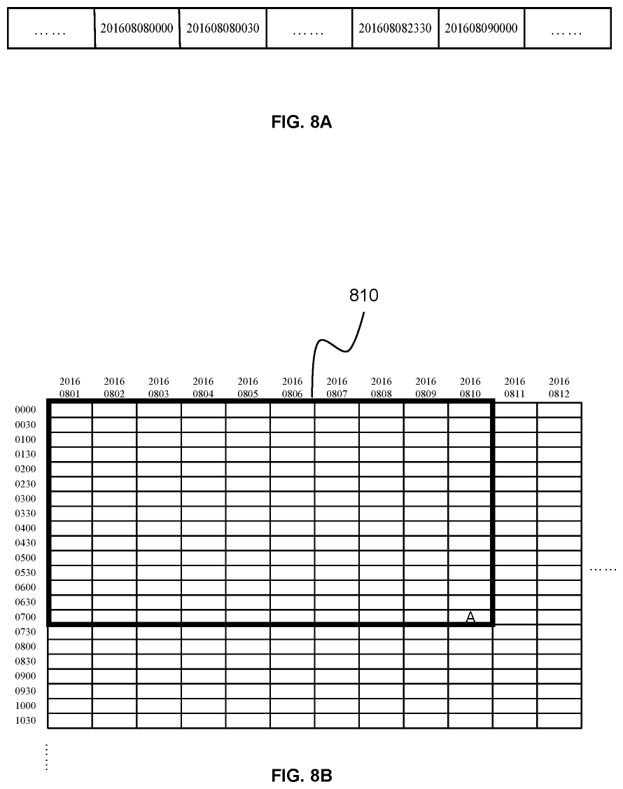

In some embodiments, the m time dimensions may include day, week, month, year, decade, century, or the like, or any combinations thereof. In some embodiments, the m time dimensions of the storage space may be set according to a default setting of the data system 100 or preset by a user or operator via the computing terminal 140. In some embodiments, the storage space determination module 440 may determine a granularity of a time dimension related to the time period of the m+1 dimensional storage space as described in connection with operation 620. In some embodiments, the storage space determination module 440 may determine m granularities of the m time dimensions of the m+1 dimensional storage space, respectively. More descriptions of the determination of the m+1 dimensional storage space may be found elsewhere in the present disclosure (e.g., FIG. 8 and the descriptions thereof).

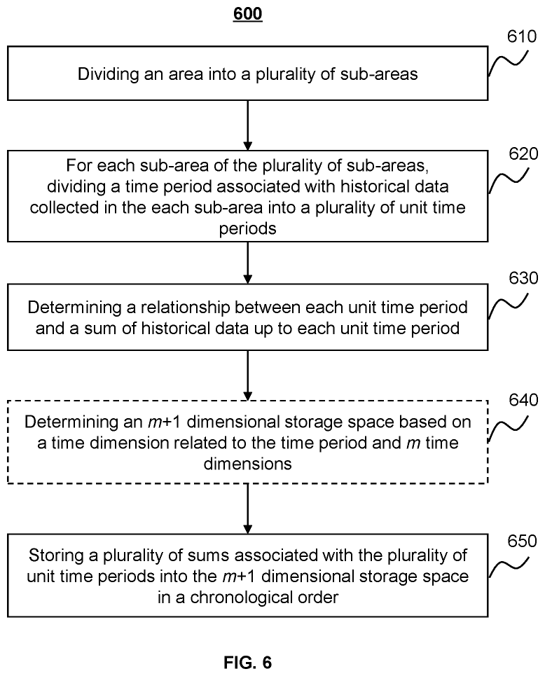

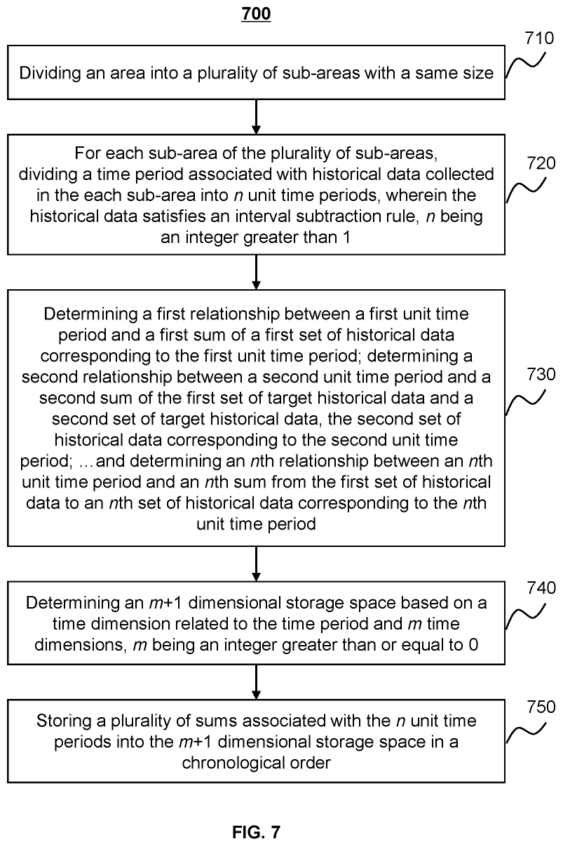

In some embodiments, the storage module 450 may store a plurality of sums associated with the plurality of unit time periods into the m+1 dimensional storage space in a chronological order. More descriptions of the storage of sums may be found elsewhere in the present disclosure (e.g., operation 650 in FIG. 6, operation 750 in FIG. 7, and descriptions thereof).

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

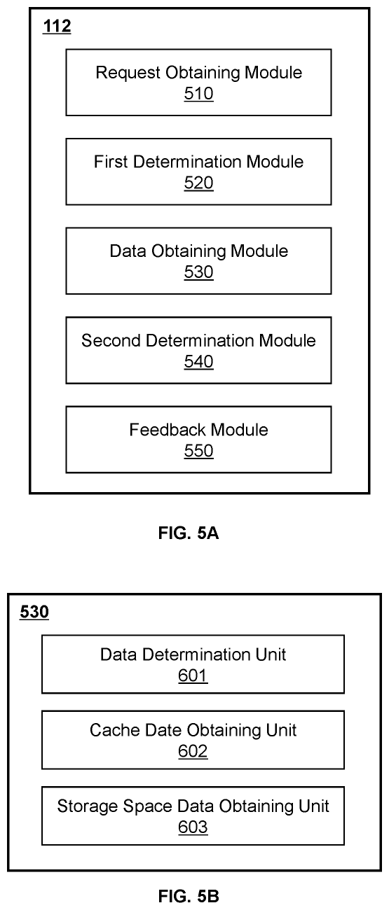

FIG. 5A is a block diagram illustrating an exemplary processing engine according to some embodiments of the present disclosure. In some embodiments, the processing engine 112 may include request obtaining module 510, a first determination module 520, a data obtaining module 530, a second determination module 540, and a feedback module 550. The modules may be hardware circuits of at least part of the processing engine 112. The modules may also be implemented as an application or set of instructions read and executed by the processing engine 112. Further, the modules may be any combination of the hardware circuits and the application/instructions. For example, the modules may be the part of the processing engine 112 when the processing engine 112 is executing the application or set of instructions.

In some embodiments, the request obtaining module 510 may receive a query request from a computing terminal. In some embodiments, the request obtaining module 510 may receive the query request from the computing terminal 140 via the network 120.

In some embodiments, the query request may be a request for historical data relating to a service. Merely for illustration purposes, the service may include a taxi service, a carpooling service, a hitch service, a delivery service, an online shopping service, a medical service, a map-based service, or the like, or any combination thereof. Taking a taxi-hailing service as an example, the query request may indicate which historical data (e.g., a number (count) of service orders, a number (or count) of service providers, a number (or count) of service requesters, a number (or count) of completed service requests) are to be queried, a queried sub-area (also referred to as a target sub-area), a time interval associated with the historical data to be queried (e.g., a starting time, an ending time), or the like, or any combination thereof.

In some embodiments, the first determination module 520 may determine, based on the query request, a target sub-area, a starting time, an ending time, time dimensions of the starting time and the ending time, a first unit time period associated with the ending time, and a second unit time period associated with the starting time. In some embodiments, the first determination module 520 may determine an initial time and/or time dimensions related to the historical data associated with the target sub-area. In some embodiments, the initial time may be a time from which each sum is determined.

In some embodiments, the first determination module 520 may determine a position in a storage space based on the target sub-area. The first determination module 520 may further determine time dimensions related to historical data associated with the target sub-area, the starting time and the ending time of the time interval during which historical data are to be queried. In some embodiments, the time dimensions of the starting time and the ending time may be lower than or equal to the time dimensions related to historical data stored in the storage space. As used herein, the time dimensions related to historical data stored in the storage space may also referred to as the time dimensions of the storage space. In some embodiments, the first determination module 520 may determine a first unit time period associated with the ending time, and a second unit time period associated with the starting time in the storage space. In some embodiments, the first unit time period may include the ending time. In some embodiments, the second unit time period may be one granularity prior to a unit time period including the starting time in each time dimension of the storage space.

In some embodiments, the data obtaining module 530 may determine a first sum of a first set of historical data from an initial time to a unit time period prior to the first unit time period, and a second sum of a second set of historical data from the initial time to a unit time period prior to the second unit time period. The historical data stored in the storage space may satisfy an interval subtraction rule. In some embodiments, the initial time may be recorded in the storage space. In some embodiments, the initial time may be determined based on historical data associated with the target sub-area.

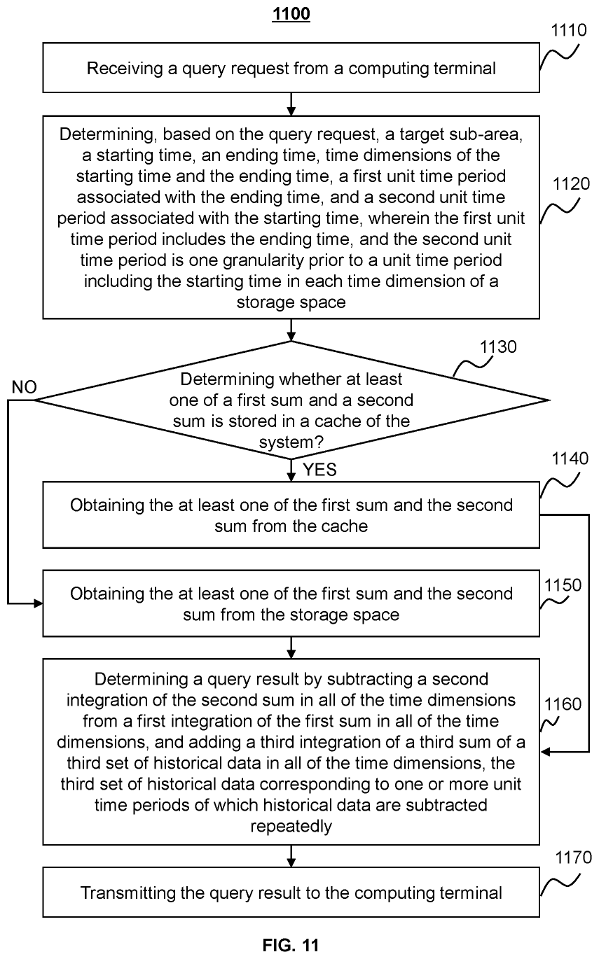

In some embodiments, the data obtaining module 530 may determine whether the first sum value and/or the second sum are stored in a cache of the data system 100. In response to a determination that the first sum value and/or the second sum are stored in the cache of the data system 100, the data obtaining module 530 may obtain the first sum value and/or the second sum from the cache of the data system 100. In response to a determination that the first sum value and/or the second sum are not stored in the cache of the data system 100, the data obtaining module 530 may obtain the first sum value and/or the second sum from the storage space. More descriptions of the determination of the first sum and/or the second sum may be found elsewhere in the present disclosure (e.g., FIG. 11 and the descriptions thereof).

In some embodiments, the second determination module 540 may determine a query result by subtracting a second integration of the second sum in all of the time dimensions from a first integration of the first sum in all of the time dimensions, and adding a third integration of a third sum of a third set of historical data in all of the time dimensions. In some embodiments, the third set of historical data may correspond to one or more unit time periods of which historical data are subtracted repeatedly.

In some embodiments, the feedback module 550 may transmit the query result to the computing terminal. In some embodiments, the feedback module 550 may transmit the query result to a visual interface of the computing terminal 140 via the network 120. In some embodiments, the visual interface of the terminal device may display the query result in the form of text, graph, audio, video, or the like, or any combination thereof.

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 5B is a block diagram illustrating an exemplary data obtaining module according to some embodiments of the present disclosure. In some embodiments, the data obtaining module 530 may include a data determination unit 601, a cache data obtaining unit 602, and a storage space data obtaining unit 603. The units may be hardware circuits of at least part of the processing engine 112. The units may also be implemented as an application or set of instructions read and executed by the processing engine 112. Further, the units may be any combination of the hardware circuits and the application/instructions. For example, the units may be the part of the processing engine 112 when the processing engine 112 is executing the application or set of instructions.

In some embodiments, the data determination unit 601 may determine whether at least one of a first sum and a second sum is stored in a cache of the system (e.g., the data system 100). In some embodiments, the cache data obtaining unit 602 may obtain the at least one of the first sum and the second sum from the cache. In some embodiments, the storage space data obtaining unit 603 may obtain the at least one of the first sum and the second sum from the storage space.

It should be noted that the above description of the data obtaining module 530 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 6 is a flow chart illustrating an exemplary process for storing data into a storage space according to some embodiments of the present disclosure. In some embodiments, the process 600 may be implemented in the data system 100. For example, the process 600 may be stored in the storage device 130 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 610, the processing engine 112 (e.g., the area division module 410) may divide an area into a plurality of sub-areas.

The area to be divided may be a geographical area. In some embodiments, the area may be determined based on the type of data to be stored in the data system 100. For example, if the data to be stored is related to a taxi hailing service (e.g., the number of service orders), the area may be a service area that the taxi hailing service covers, e.g., a city block, an airport, or the like. As another example, if the data to be stored is related to an agriculture service (e.g., a crop yield), the area may be a crop planting area.

In some embodiments, the processing engine 112 may divide the area randomly. Additionally and/or alternatively, the processing engine 112 may divide the area based on one or more parameters, such as a size of the area, a division of an administrative area (e.g., a country, a province, a city, or a district), longitudinal and latitudinal coordinates, or the like, or any combination thereof. The sub-areas may have any size and/or shape. The shapes and/or sizes of different sub-areas may be the same or different. In some embodiments, the processing engine 112 may divide the area into a plurality of sub-areas with the same size and/or the same shape. For example, the processing engine 112 may uniformly divide the area into a plurality of sub-areas having a polygonal shape, such as a regular triangle (e.g., an equilateral triangle with a side length of 500 meters), a rectangle (e.g., a rectangle with a length of 500 meters and a width of 300 meters), a square, or a regular hexagon, or the like.

In 620, for each sub-area of the plurality of sub-areas, the processing engine 112 (e.g., the time period division module 420) may divide a time period associated with the historical data collected in the each sub-area into a plurality of unit time periods.

The historical data may relate to a service provided in the sub-area. Merely for illustration purposes, the service may include a taxi hailing service, a carpooling service, a hitch service, a delivery service, an online shopping service, a medical service, a map-based service, or the like, or any combination thereof. Take the taxi-hailing service as an example, the historical data may include a number (or count) of service orders generated in a sub-area, a number (or count) of service providers positioned in a sub-area, a number (or count) of service requesters positioned in a sub-area, a number (or count) of completed service requests in a sub-area, or the like.

In some embodiments, the historical data may satisfy an interval subtraction rule. For example, in the case of a<b<c (a, b, and c are real numbers), if historical data in a first interval [a, c] and a second interval [b, c] in a same sub-area (or area) are known, the processing engine 112 may determine historical data in a third interval [a, b] in the same sub-area (or area) by subtracting the historical data in the second interval [b, c] from the historical data in the first interval [a, c]. As another example, if the historical data in the first interval [a, c] and the third interval [a, b] in a same sub-area (or area) are known, the processing engine 112 may determine the historical data in the second interval [b, c] by subtracting the historical data in the third interval [a, b] from the historical data in the first interval [a, c]. Take the number (or count) of service orders in the taxi hailing service as an example, if the number (or count) of service orders from 7:00 am to 9:00 am is 1 million in a certain sub-area (or area), and the number (or count) of service orders from 7:00 am to 8:00 am is 0.4 million in the same sub-area (or area), then the number (or count) of service orders from 8:00 am to 9:00 am may be determined as 0.6 million (i.e., 1 million-0.4 million=0.6 million) in the same sub-area (or area).

In some embodiments, the time period associated with the historical data of the each sub-area may be a year, a month, a week, a day, or any time period from a starting time to an ending time. For example, if the historical data are the number (or count) of service orders generated in sub-area A from 8:00 am, Jun. 1, 2017 to 9:00 pm, Dec. 25, 2017, the time period may be from 8:00 am, Jun. 1, 2017 to 9:00 pm, Dec. 25, 2017. In some embodiments, the time period may be set according to a default setting of the data system 100 or preset by a user or operator via the computing terminal 140. Accordingly, the historical data according to the determined time period may be collected. For example, if the time period is set as 0:00 am, Jun. 1, 2017 to 0:00 am, Jul. 1, 2017, and the historical data are the number (or count) of service orders generated in a sub-area B, then the service orders generated in the sub-area B within the time period may be collected.

In some embodiments, the duration of a unit time period (also referred to as a granularity of the unit time period) may be, for example, 0.5 hour, 1 hour, 5 hours, 10 hours, or 24 hours, or the like. For example, the duration of the unit time period may be 0.5 hour, and one day may be divided into 48 unit time periods. In some embodiments, the duration of the unit time period may be set manually or be determined by one or more components of the data system 100 according to different situations. For example, the unit time period may be set according to a default setting of the data system 100 or preset by a user or operator via the computing terminal 140. In some embodiments, the processing engine 112 may divide the time period into a plurality of unit time periods based on the duration of a unit time period. In some embodiments, the processing engine 112 may divide the time period into a plurality of unit time periods based on a predetermined number (or count) of the unit time periods. In some embodiments, the number (or count) of the unit time periods may be set according to a default setting of the data system 100 or preset by a user or operator via the computing terminal 140. In some embodiments, the processing engine 112 may uniformly divide the time period into a plurality of unit time periods.

In 630, the processing engine 112 (e.g., the associating module 430) may determine a relationship between each unit time period and a sum of historical data up to each unit time period.

In some embodiments, the processing engine 112 may determine a sum of historical data from a start time of the time period to each unit time period. In some embodiments, the processing engine 112 may associate the sum of historical data with each unit time period. For example, the processing engine 112 may divide time period associated with historical data of a sub-area into n unit time periods, wherein n may be an integer greater than 1. For an ith unit time period in the n unit time periods, the processing engine 112 may determine an ith sum of historical data from the start time of the time period to the ith unit time period, wherein i may be an integer greater than 1 and less than or equal to n. The processing engine 112 may associate the ith sum with the ith unit time period.

In 640, the processing engine 112 (e.g., the storage space determination module 440) may determine an m+1 dimensional storage space based on a time dimension related to the time period and m time dimensions. In some embodiments, m may be an integer greater than or equal to 0.

In some embodiments, the m time dimensions may include day, week, month, year, decade, century, or the like, or any combinations thereof. In some embodiments, the m time dimensions of the storage space may be set according to a default setting of the data system 100 or preset by a user or operator via the computing terminal 140. For example, as illustrated in FIG. 8A, the storage space may be a one dimensional storage space (i.e., m=0), and the time dimension of the storage space may be related to the time period. As another example, as illustrated in FIG. 8B, the storage space may be a two dimensional storage space (i.e., m=1), and the time dimensions of the storage space may be related to the time period and day.

In some embodiments, the processing engine 112 may determine a granularity of a time dimension related to the time period of the m+1 dimensional storage space as described in connection with operation 620. In some embodiments, the processing engine 112 may determine m granularities of the m time dimensions of the m+1 dimensional storage space, respectively. More descriptions of the determination of the m+1 dimensional storage space may be found elsewhere in the present disclosure (e.g., FIG. 8 and the descriptions thereof).

In 650, the processing engine 112 (e.g., the storage module 450) may store a plurality of sums associated with the plurality of unit time periods into the m+1 dimensional storage space in a chronological order.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added or omitted. For example, a storing operation may be added in process 600. In the storing operation, the processing engine 112 may store information and/or data associated with a storage space in a storage medium (e.g., the storage device 130), which is disclosed elsewhere in the present disclosure. As another example, operation 640 may be omitted. The storage space may be a default storage space in a storage device (e.g., the storage device 130) of the data system 100. In some embodiments, the order of the operations in process 600 may be changed. For example, operation 640 may be performed before operation 610 or operation 620. As another example, operation 620 may be performed before operation 610. That is, the processing engine 112 may divide a time period associated with historical data of an area into a plurality of unit time periods. For each unit time period, the processing engine 112 may then divide the area into a plurality of sub-areas. Further, the processing engine 112 may store historical data associated with the plurality of sub-areas into a storage space as described in the present disclosure.

In some embodiments, after dividing an area into a plurality of sub-areas, for each sub-area, the processing engine 112 may divide a plurality of users (e.g., a plurality of service providers or service requesters in a plurality of taxi hailing service orders) in the each sub-area into multiple groups according to one or more parameters (e.g., age, education background). Further, the processing engine 112 may store historical data associated with the users in different groups into a storage space as described in the present disclosure.

FIG. 7 is a flow chart illustrating an exemplary process for storing data into a storage space according to some embodiments of the present disclosure. In some embodiments, the process 700 may be implemented in the data system 100. For example, the process 700 may be stored in the storage device 130 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 710, the processing engine 112 (e.g., the area division module 410) may divide an area into a plurality of sub-areas with a same size.

In some embodiments, the area may be determined based on the type of data to be stored in the data system 100. For example, if the data to be stored are related to a taxi hailing service (e.g., the number of service orders), the area may be a service area that the taxi hailing service covers, e.g., a city block, an airport, or the like. As another example, if the data to be stored is related to an agriculture service (e.g., a crop yield), the area may be a crop planting area. Data relating to a taxi hailing service (e.g., the number of service orders) are taken as an example in the following descriptions. It should be noted that the descriptions are merely provided for the purposes of illustration and not intended to limit the scope of the present disclosure.

In some embodiments, the shapes and/or sizes of different sub-areas may be set manually by a user, or may be determined by one or more components of the data system 100 according to different situations. For example, the sub-area may be an equilateral triangle with a side length of 500 meters, a rectangle with a length of 500 meters and a width of 300 meters, or the like.

More descriptions of operation 710 may be found elsewhere in the present disclosure (e.g., operation 610 in FIG. 6 and descriptions thereof).

In 720, for each sub-area of the plurality of sub-areas, the processing engine 112 (e.g., the time period division module 420) may divide a time period associated with historical data collected in the each sub-area into n unit time periods, wherein the historical data may satisfy an interval subtraction rule, and n may be an integer greater than 1.

In some embodiments, the historical data may satisfy an interval subtraction rule. For example, in the case of a<b<c (a, b, and c are real numbers), if historical data in intervals [a, c] and [b, c] are known, the processing engine 112 may determine historical data in an interval [a, b] by subtracting the historical data in the interval [b, c] from the historical data in the interval [a, c]. As another example, if the historical data in the intervals [a, c] and [a, b] are known, the processing engine 112 may determine the historical data in the interval [b, c] by subtracting the historical data in the interval [a, b] from the historical data in the interval [a, c].

Taking the number of service orders in taxi hailing services as an example, if the number (or count) of service orders from 7:00 am to 9:00 am is 1 million in a certain sub-area (or area), and the number (or count) of service orders from 7:00 am to 8:00 am is 0.4 million in the same sub-area (or area), then the number (or count) of service orders from 8:00 am to 9:00 am may be determined as 0.6 million (i.e., 1 million-0.4 million=0.6 million) in the same sub-area (or area).

In some embodiments, for each sub-area, the time period associated with the historical data of the each sub-area may be divided into n unit time periods with the same time duration. In some embodiments, the duration of a unit time period (also referred to as a granularity of the unit time period) may be set manually or be determined by one or more components of the data system 100 according to different situations. The duration of a unit time period may be, for example, 0.5 hour, 1 hour, 5 hours, 10 hours, or 24 hours, or the like. For example, the duration of each unit time period may be 0.5 hour, and one day may be divided into 48 unit time periods.

More descriptions of operation 720 may be found elsewhere in the present disclosure (e.g., operation 620 in FIG. 6 and descriptions thereof).

In 730, the processing engine 112 (e.g., the associating module 430) may determine a first relationship between a first unit time period and a first sum of a first set of historical data corresponding to the first unit time period. The processing engine 112 (e.g., the associating module 430) may determine a second relationship between a second unit time period and a second sum of the first set of target historical data and a second set of target historical data, wherein the second set of historical data correspond to the second unit time period. Similarly, the processing engine 112 (e.g., the associating module 430) may determine an nth relationship between an nth unit time period and an nth sum from the first set of historical data to an nth set of historical data corresponding to the nth unit time period.

In some embodiments, if the duration of a unit time period is 0.5 hour, i.e., one day is divided into 48 unit time periods. For a first unit time period 00:00˜00:30, the processing engine 112 may determine a first relationship between the first unit time period and a first sum of a first set of historical data corresponding to the first unit time period. Taking the number (or count) of service orders in taxi hailing services as an example, if the number (or count) of service orders in the first unit time period is 0.1 million, then the first sum may be 0.1 million. For a second unit time period 00:30˜01:00, the processing engine 112 may determine a second relationship between the second unit time period and a second sum of the first set of historical data and a second set of historical data. The second set of historical data may correspond to the second unit time period. For example, if the number (or count) of service orders in the first unit time period is 0.1 million, and the number (or count) of service orders in the second unit time period is 0.12 million, then the second sum may be 0.22 million (i.e., 0.1 million+0.12 million=0.22 million). For an nth unit time period 23:30˜00:00, the processing engine 112 may determine an nth relationship between the nth unit time period and an nth sum from the first set of historical data to an nth set of historical data corresponding to the nth unit time period. For example, the nth sum may be 0.5 million.

In 740, the processing engine 112 (e.g., the storage space determination module 440) may determine an m+1 dimensional storage space based on a time dimension related to the time period and m time dimensions, wherein m may be an integer greater than or equal to 0.

In some embodiments, the processing engine 112 may determine a granularity of a time dimension related to the time period of the m+1 dimensional storage space as described in connection with operation 620 or operation 720. In some embodiments, the processing engine 112 may determine m granularities of the m time dimensions of the m+1 dimensional storage space, respectively. More descriptions of the determination of the m+1 dimensional storage space may be found elsewhere in the present disclosure (e.g., FIGS. 6 and 8 and the descriptions thereof).

In 750, the processing engine 112 (e.g., the storage module 450) may store a plurality of sums associated with the n unit time periods into the m+1 dimensional storage space in a chronological order.

In some embodiments, for the purposes of illustration, the string “201608080930” may represent a sum of a set of historical data corresponding to the unit time period 9:30˜10:00 in Aug. 8, 2016. Accordingly, each sum corresponding to each unit time period in Aug. 8, 2016 may be represented by “201608080000”˜“201608082330”.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 8A is a schematic diagram illustrating an exemplary one dimensional storage space according to some embodiments of the present disclosure. As illustrated, the dimension of the storage space is related to the time period (i.e., m=0), and the granularity of the time period dimension is 0.5 hour. In some embodiments, a plurality of sums associated with a plurality of unit time periods may be stored into the one dimensional storage space in a chronological order. That is, a sum associated with a relatively early unit time period may be stored at a closer position relative to a start position of the one dimensional storage space, and accordingly, a sum associated with a relatively late unit time period may be stored at a farther position relative to the start position of the one dimensional storage space.

As shown in FIG. 8A, the unit time periods in the storage space may include a 1st unit time period 00:00˜00:30 in Aug. 8, 2016, a 2nd unit time period 00:30˜01:00 in Aug. 8, 2016, . . . a 48th unit time period 23:30 in Aug. 8, 2016˜00:00 in Aug. 9, 2016, and a 49th unit time period 00:00˜00:30 in Aug. 9, 2016. The strings “201608080000”, “201608080030”, . . . , “201608082330”, and “201608090000” represent sums of historical data corresponding to the unit time periods, respectively. Specifically, the string “201608080000” may represent the sum of a first set of historical data corresponding to the 1st unit time period 00:00˜00:30 in Aug. 8, 2016; the string “201608080030” may represent the sum of the first set of historical data and a second set of historical data corresponding to the 2nd unit time period 00:30˜01:00 in Aug. 8, 2016; the string “201608082330” may represent the sum from the first set of historical data to a 48th set of historical data corresponding to the 48th unit time period 23:30 in Aug. 8, 2016˜00:00 in Aug. 9, 2016; the string “201608090000” may represent the sum from the first set of historical data to a 49th set of historical data corresponding to the 49th unit time period 00:00˜00:30 in Aug. 9, 2016. The sum represented by the string “201608080000” may be less than the sum represented by the string “201608080030”.

In some embodiments, the historical data may satisfy an interval subtraction rule. Therefore, in order to query data associated with a certain time interval (also referred to as a time period), a user or the processing engine 112 may only need to determine a starting time of the certain time interval and an ending time of the certain time interval, and perform a subtraction operation based on the sums associated with the starting time and the ending time of the certain time interval.

For example, for a one dimensional storage space shown in FIG. 8A, if a user inputs a request for querying historical data (e.g., the number (or count) of service orders) in a time interval from 12:30 am, Aug. 8, 2016 to 5:00 am, Aug. 9, 2016, the processing engine 112 may determine a first sum associated with a first unit time period (i.e., the first sum represented by a string “201608081230”) (i.e., associated with a starting time of the time interval), and a second sum associated with a second unit time period (i.e., the second sum represented by a string “201608090430”) (e.g., associated with an ending time of the time interval). The processing engine 112 may further determine the query result by subtracting the first sum (e.g., the number (or count) of service orders) represented by the string “201608081200” from the second sum (e.g., the number (or count) of service orders) represented by the string “201608090430”.

FIG. 8B is a schematic diagram illustrating an exemplary two dimensional storage space according to some embodiments of the present disclosure. As illustrated, the horizontal dimension of the storage space may be related to day (e.g., from Aug. 1, 2016 to Aug. 12, 2016), and the vertical dimension of the storage space may be related to unit time periods (e.g., from a unit time period 00:00˜00:30 to a unit time period 10:30˜11:00). The granularity of the horizontal dimension may be one day and the granularity of the vertical dimension may be 0.5 hour. Each day in the horizontal dimension may correspond to 48 unit time periods in the vertical dimension. In some embodiments, the horizontal dimension of the storage space may be set according to a default setting of the data system 100 or preset by a user or operator via the computing terminal 140. For example, the horizontal dimension of the storage space may be month, year, or the like.

In some embodiments, the processing engine 112 may store the plurality of sums associated with the plurality of unit time periods into the storage space according to the time dimensions of the storage space. For example, in a multi-dimensional storage space, a sum associated with a certain unit time period in the multi-dimensional storage space may refer to a sum of historical data corresponding to unit time periods prior to the certain unit time period in each dimension of the storage space. For example, as shown in FIG. 8B, if 00:00 in Aug. 1, 2016 is the starting time of the time period, and 07:00 in Aug. 10, 2016 is the ending time of the time period, then the data represented by a string “201608100700” associated with the unit time period illustrated as A may be a sum of a plurality of sets of historical data associated with a plurality of unit time periods illustrated in the area 810.

In some embodiments, similar to the data stored in one dimensional storage space, the historical data stored in the two dimensional storage space may satisfy the interval subtraction rule. Therefore, the processing engine 112 may determine historical data in a time interval by performing one or more subtraction operations.

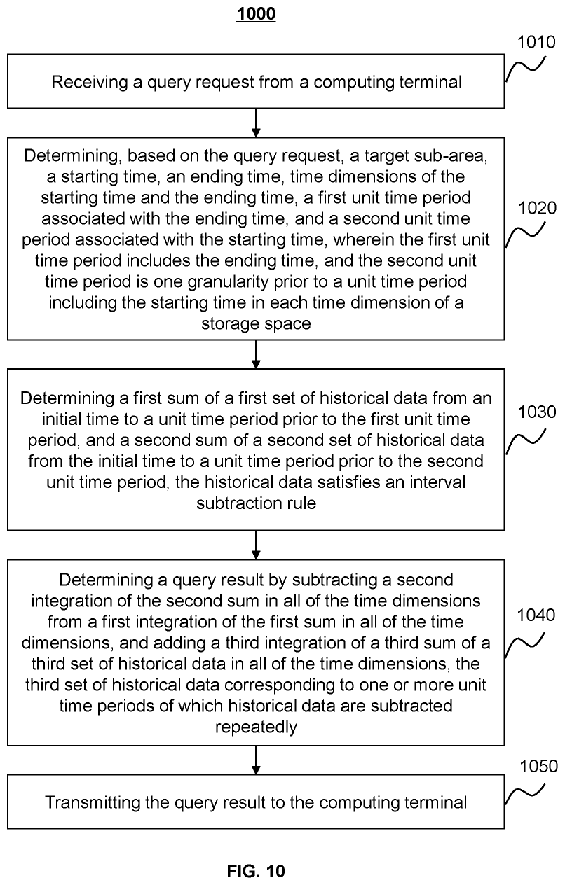

For example, as shown in FIG. 8B, if a user inputs a request (or the data system 100 receives a request) for querying historical data (e.g., the number (or count) of service orders) in a time interval of 7:00 am˜9:30 am in each day from Aug. 7, 2016 to Aug. 12, 2016, the processing engine 112 may determine a query result by subtracting a first sum represented by a string “201608060900” and a second sum represented by a string “201608120630” from a third sum represented by a string “201608120900”, and adding a fourth sum represented by a string “201608060630” which is repeatedly subtracted. The first sum represented by the string “201608060900” may correspond to a position labelled as “20160806” (i.e., Aug. 6, 2016) in the horizontal dimension and “0900” (i.e., 09:00) in the vertical dimension. The second sum represented by the string “201608120630” may correspond to a position labelled as “20160812” (i.e., Aug. 12, 2016) in the horizontal dimension and “0630” (i.e., 06:30) in the vertical dimension. The third sum represented by the string “201608120900” may correspond to a position labelled as “20160812” (i.e., Aug. 12, 2016) in the horizontal dimension and “0900” (i.e., 09:00) in the vertical dimension. The fourth sum represented by the string “201608060630” may correspond to a position labelled as “20160806” (i.e., Aug. 6, 2016) in the horizontal dimension and “0630” (i.e., 06:30) in the vertical dimension. More descriptions of the determination of a query result based on a query request may be found elsewhere in the present disclosure (e.g., FIGS. 10-11, and the descriptions thereof).

According to the data storage methods described in the present disclosure, on the one hand, the processing engine 112 may store a plurality of sums associated with a plurality of unit time periods into the storage space instead of storing each of the historical data. For example, for historical data relating to 100,000 service orders, the processing engine 112 may only store the sum (i.e., 100,000) instead of storing historical data relating to each of the 100,000 service orders, therefore, the storage space occupied may be significantly reduced. On the other hand, since the historical data stored in the storage space may satisfy the interval subtraction rule, the processing engine 112 may determine historical data in a certain time interval in the storage space by performing one or more subtraction operations on the sums stored in the storage space, therefore, query speed may be significantly improved. For example, for tens of millions of historical data relating to taxi-hailing services every day, using the data storage methods described in the present disclosure, the query speed can be improved from a fraction of a second to several milliseconds, and this beneficial technical effect may be more obvious for a larger amount of data.

It should be noted that the dimension of the storage space (e.g., m) may be improved on the basis of the two dimensional storage space shown in FIG. 8B. For example, in addition to the dimensions related to day and unit time period, other dimensions related to month and/or year may be set for multi-dimensional storage space.

In some embodiments, each unit time period in the storage space (e.g., storage spaces as illustrated in FIGS. 8A and 8B, or a multi-dimensional storage space not shown in the preset disclosure) may correspond to a space dimension, for example, a sub-area. That is, each sub-area may correspond to a storage space (e.g., the one dimensional storage space as illustrated in FIG. 8A, the two dimensional storage space as illustrated in FIG. 8B, or any other multi-dimensional storage space). In some embodiments, the processing engine 112 may determine the space dimension (e.g., the sub-area(s)) according to longitude coordinate and latitude coordinate. For example, if the granularity of the longitude coordinate is 0.005, and the granularity of the latitude coordinate is 0.005, then the processing engine 112 may store historical data relating to a sub-area with longitude coordinates between 116.215 and 116.220 and latitude coordinates between 40.460 and 40.465, in a position represented by “116215_40460” in a storage space.

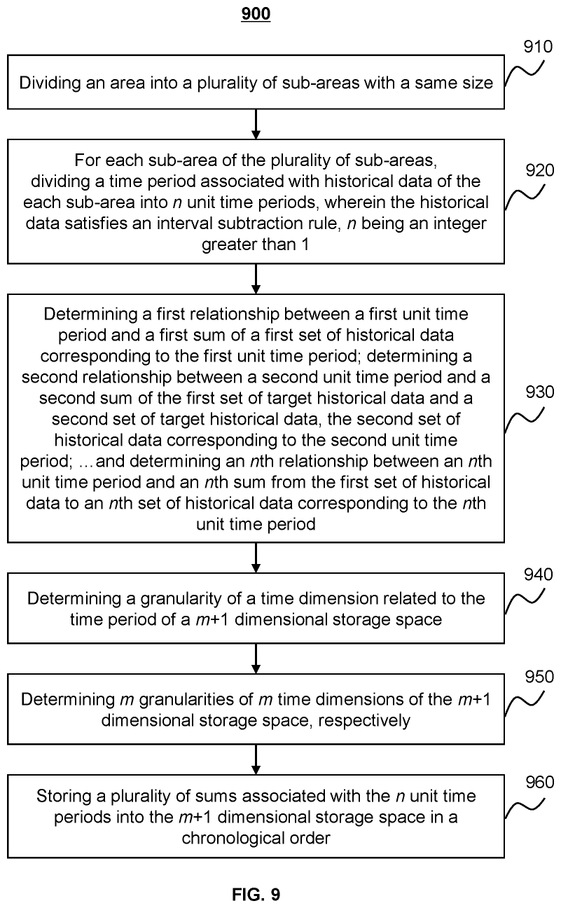

FIG. 9 is a flow chart illustrating an exemplary process for storing data into a storage space according to some embodiments of the present disclosure. In some embodiments, the process 900 may be implemented in the data system 100. For example, the process 900 may be stored in the storage device 130 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 910, the processing engine 112 (e.g., the area division module 410) may divide an area into a plurality of sub-areas with a same size. More descriptions of the division of an area may be found elsewhere in the present disclosure (e.g., operation 610 in FIG. 6, operation 710 in FIG. 7, and descriptions thereof).

In 920, for each sub-area of the plurality of sub-areas, the processing engine 112 (e.g., the time period division module 420) may divide a time period associated with historical data of the each sub-area into n unit time periods, wherein n may be an integer greater than 1. The historical data may satisfy an interval subtraction rule. More descriptions of the division of a time period may be found elsewhere in the present disclosure (e.g., operation 620 in FIG. 6, operation 720 in FIG. 7, and descriptions thereof).

In 930, the processing engine 112 (e.g., the associating module 430) may determine a first relationship between a first unit time period and a first sum of a first set of historical data corresponding to the first unit time period. The processing engine 112 (e.g., the associating module 430) may determine a second relationship between a second unit time period and a second sum of the first set of target historical data and a second set of target historical data, wherein the second set of historical data correspond to the second unit time period. Similarly, the processing engine 112 (e.g., the associating module 430) may determine an nth relationship between an nth unit time period and an nth sum from the first set of historical data to an nth set of historical data corresponding to the nth unit time period. More descriptions of the determination of the relationships between unit time periods and sums may be found elsewhere in the present disclosure (e.g., operation 630 in FIG. 6, operation 730 in FIG. 7, and descriptions thereof).

In 940, the processing engine 112 (e.g., the storage space determination module 440) may determine a granularity of a time dimension related to the time period of an m+1 dimensional storage space.

In some embodiments, the processing engine 112 may determine the granularity of the time dimension related to the time period when dividing the time period associated with the historical data of the sub-area. For example, as illustrated in FIGS. 8A and 8B, the duration of a unit time period is 0.5 hour, in this situation, the granularity of the time dimension related to the time period of the storage space is 0.5 hour.

In 950, the processing engine 112 (e.g., the storage space determination module 440) may determine m granularities of m time dimensions of the m+1 dimensional storage space, respectively.

In some embodiments, the processing engine 112 may determine the m time dimensions other than the time dimension related to the time period, wherein m may be an integer greater than or equal to 0. In some embodiments, the m time dimensions may include day, week, month, year, or the like, or any combination thereof. The m time dimensions may be preset manually by a user, or may be determined by one or more components of the data system 100 according to different situations. The processing engine 112 may also determine the m granularities of the m time dimensions of the m+1 dimensional storage space. Further, the processing engine 112 may determine the m+1 dimensional storage space based on the time dimension related to the time period and the m time dimensions. It should be noted that the processing engine 112 may determine different storage spaces based on different time dimensions. In some embodiments, if one time dimension of the storage space changes, one or more other time dimensions may change accordingly. For example, if the time dimension is day, then one day may correspond to 48 unit time periods. If the time dimension is week, then one week may correspond to 336 unit time periods.

In 960, the processing engine 112 (e.g., the storage module 450) may store a plurality of sums associated with the n unit time periods into the m+1 dimensional storage space in a chronological order. More descriptions of the storage of sums may be found elsewhere in the present disclosure (e.g., operation 650 in FIG. 6, operation 750 in FIG. 7, and descriptions thereof).

In some embodiments, each sub-area may have a shape of a rectangle. In some embodiments, if the shape of each sub-area is set as rectangle, it may be facilitated that the historical data in the sub-area satisfy the interval subtraction rule, and then any further data query operation may be facilitated, and the query result may be more accurate.

In some embodiments, the storage space illustrated in the present disclosure may be a key-value database, and accordingly, the unit time period and other m time dimensions may be set as primary keys of the key-value database. In some embodiments, the key-value database may provide a quick query speed, allow storage of a large amount of data, support high concurrency, and may be suitable for query by one or more primary keys. In some embodiments, the historical data stored in the storage space satisfy the interval subtraction rule. In data query, the processing engine 112 may determine the query result based on a first position in the storage space corresponding to a starting time of a time interval, a second position in the storage space corresponding to an ending time of the time interval, and a subtraction operation. In some embodiments, the first position in the storage space corresponding to the starting time of the time interval and the second position in the storage space corresponding to the ending time of the time interval may be determined based on corresponding primary keys, and accordingly, the query result may be determined in a high speed. In some embodiments, if one or more historical data are subtracted repeatedly, the historical data may be added into the query result. In some embodiments, if the time dimension of the storage space is larger than 1, the add operation may be performed to recover the historical data subtracted repeatedly.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

For example, operation 950 may be omitted. The storage space may be a one dimensional storage space (i.e., m=0) as described in FIG. 8A.

FIG. 10 is a flow chart illustrating an exemplary process for querying data according to some embodiments of the present disclosure. In some embodiments, the process 1000 may be implemented in the data system 100. For example, the process 1000 may be stored in the storage device 130 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 1010, the processing engine 112 (e.g., the request obtaining module 510) may receive a query request from a computing terminal. In some embodiments, the processing engine 112 may receive the query request from the computing terminal 140 via the network 120.

In some embodiments, the network 120 may establish a communication (e.g., wireless communication) between the server 110 and the computing terminal 140, for example, through an application (e.g., the application 380 in FIG. 3) installed in the computing terminal 140. In some embodiments, the application may be configured to provide a service (e.g., an online to offline service) for a user. For example, the application may be associated with a taxi-hailing service. In some embodiments, the user may log into the application and initiate a query request. In some embodiments, when the application installed in the computing terminal 140 is launched, query request from the user may be continuously or periodically monitored. Once a query request is detected by the application, the computing terminal 140 may automatically transmit the query request to the processing engine 112 via the network 120.

In some embodiments, the query request may be a request for historical data relating to a service. Merely for illustration purposes, the service may include a taxi service, a carpooling service, a hitch service, a delivery service, an online shopping service, a medical service, a map-based service, or the like, or any combination thereof. Taking a taxi-hailing service as an example, the query request may indicate which historical data (e.g., a number (count) of service orders, a number (or count) of service providers, a number (or count) of service requesters, a number (or count) of completed service requests) are to be queried, a queried sub-area (also referred to as a target sub-area), a time interval associated with the historical data to be queried (e.g., a starting time, an ending time), or the like, or any combination thereof.

In 1020, the processing engine 112 (e.g., the first determination module 520) may determine, based on the query request, a target sub-area, a starting time, an ending time, time dimensions of the starting time and the ending time, a first unit time period associated with the ending time, and a second unit time period associated with the starting time. In some embodiments, the processing engine 112 may determine an initial time and/or time dimensions related to the historical data associated with the target sub-area. In some embodiments, the initial time may be a time from which each sum is determined.

In some embodiments, the processing engine 112 may determine a position in a storage space based on the target sub-area. The processing engine 112 may further determine time dimensions related to historical data associated with the target sub-area, the starting time and the ending time of the time interval during which historical data are to be queried. In some embodiments, the time dimensions of the starting time and the ending time may be lower than or equal to the time dimensions related to historical data stored in the storage space. As used herein, the time dimensions related to historical data stored in the storage space may also referred to as the time dimensions of the storage space.

In some embodiments, after determining the starting time and the ending time of the queried historical data, the processing engine 112 may determine a first unit time period associated with the ending time, and a second unit time period associated with the starting time in the storage space. In some embodiments, the first unit time period may include the ending time. In some embodiments, the second unit time period may be one granularity prior to a unit time period including the starting time in each time dimension of the storage space.

In 1030, the processing engine 112 (e.g., the data obtaining module 530) may determine a first sum of a first set of historical data from an initial time to a unit time period prior to the first unit time period, and a second sum of a second set of historical data from the initial time to a unit time period prior to the second unit time period. The historical data stored in the storage space may satisfy an interval subtraction rule. In some embodiments, the initial time may be recorded in the storage space. In some embodiments, the initial time may be determined based on historical data associated with the target sub-area.

In some embodiments, the processing engine 112 may determine whether the first sum value and/or the second sum are stored in a cache of the data system 100. In response to a determination that the first sum value and/or the second sum are stored in the cache of the data system 100, the processing engine 112 may obtain the first sum value and/or the second sum from the cache of the data system 100. In response to a determination that the first sum value and/or the second sum are not stored in the cache of the data system 100, the processing engine 112 may obtain the first sum value and/or the second sum from the storage space. More descriptions of the determination of the first sum and/or the second sum may be found elsewhere in the present disclosure (e.g., FIG. 11 and the descriptions thereof).

In 1040, the processing engine 112 (e.g., the second determination module 540) may determine a query result by subtracting a second integration of the second sum in all of the time dimensions from a first integration of the first sum in all of the time dimensions, and adding a third integration of a third sum of a third set of historical data in all of the time dimensions. In some embodiments, the third set of historical data may correspond to one or more unit time periods of which historical data are subtracted repeatedly.

In 1050, the processing engine 112 (e.g., the feedback module 550) may transmit the query result to the computing terminal. In some embodiments, the processing engine 112 may transmit the query result to a visual interface of the computing terminal 140 via the network 120. The visual interface of the terminal device may display the query result in the form of text, graph, audio, video, or the like, or any combination thereof.

For example, a user may query a number (or count) of service orders in a time interval of 7:00 am˜9:30 am in each day from Aug. 7, 2016 to Aug. 12, 2016 in a two dimensional storage space as illustrated in FIG. 8B. The processing engine 112 may determine a first unit time period including the ending time (i.e., 9:30 am, Aug. 12, 2016). The first unit time period may correspond to a position labelled as “20160812” (i.e., Aug. 12, 2016) in the horizontal dimension and “0930” (i.e., 09:30) in the vertical dimension. The processing engine 112 may determine a second unit time period associated with the starting time (i.e., 7:00 am, Aug. 7, 2016). The second unit time period may be one granularity prior to a unit time period including the starting time in the time dimensions related to day and unit time period of the two dimensional storage space illustrated in FIG. 8B. For example, one granularity prior to the unit time period including the starting time in the time dimension related to day may be “20160806”, and one granularity prior to the unit time period including the starting time in the time dimension related to unit time period may be “0630”. Accordingly, the second unit time period may correspond to a position labelled as “20160806” (i.e., Aug. 6, 2016) in the horizontal dimension and “0630” (i.e., 06:30) in the vertical dimension.

The processing engine 112 may also determine a first sum associated with the first unit time period, and a second sum associated with the second unit time period. The first sum may be a sum of a first set of historical data from the initial time (e.g., 00:00 am, Aug. 1, 2016 as illustrated in FIG. 8B) recorded in the storage space to a unit time period prior to the first unit time period in the two dimensions of the storage space. The second sum may be a sum of a second set of historical data from the initial time (e.g., 00:00 am, Aug. 1, 2016 as illustrated in FIG. 8B) recorded in the storage space to a unit time period prior to the second unit time period in the two dimensions of the storage space. In some embodiments, the first sum may be represented by a string “201608120900”. In some embodiments, the second sum may be represented by a string “201608060630”.

The processing engine 112 may further determine a query result based on a first difference value of the first sum and the second sum in the time dimension related to day of the storage space, a second difference value of the first sum and the second sum in the time dimension related to unit time period of the storage space, and a third sum. For example, the processing engine 112 may determine the first difference value by subtracting a sum associated with a unit time period (labelled as “20160806” in the horizontal dimension and “0900” in the vertical dimension) from the first sum associated with the first unit time period (labelled as “20160812” in the horizontal dimension and “0900” in the vertical dimension). The processing engine 112 may determine the second difference value by subtracting a sum associated with a unit time period (labelled as “20160812” in the horizontal dimension and “0630” in the vertical dimension) from the first difference value. Both the sums associated with the unit time period (labelled as “20160806” in the horizontal dimension and “0900” in the vertical dimension) and the unit time period (labelled as “20160812” in the horizontal dimension and “0630” in the vertical dimension) may include a third sum associated with the unit time period (labelled as “20160806” in the horizontal dimension and “0630” in the vertical dimension). The third sum may be subtracted repeatedly during the determination of the second difference value. Accordingly, the processing engine 112 may determine the query result by adding the third sum to the second difference value.

It should be noted that the data query process illustrated in FIG. 10 may only include one or more subtraction operations and/or one or more adding operations. There may be no complex operations. Therefore, query speed may be accelerated.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added or omitted. For example, a storing operation may be added in process 1000. In the storing operation, the processing engine 112 may store information and/or data associated with a query request in a storage medium (e.g., the storage device 130), which is disclosed elsewhere in the present disclosure. As another example, operation 1050 may be omitted.

FIG. 11 is a flow chart illustrating an exemplary process for querying data according to some embodiments of the present disclosure. In some embodiments, the process 1100 may be implemented in the data system 100. For example, the process 1100 may be stored in the storage device 130 and/or the storage (e.g., the ROM 230, the RAM 240, etc.) as a form of instructions, and invoked and/or executed by the server 110 (e.g., the processing engine 112 in the server 110, or the processor 210 of the processing engine 112 in the server 110).

In 1110, the processing engine 112 (e.g., the request obtaining module 510) may receive a query request from a computing terminal. More descriptions of operation 1110 may be found elsewhere in the present disclosure (e.g., operation 1010 in FIG. 10 and descriptions thereof).

In 1120, the processing engine 112 (e.g., the first determination module 520) may determine, based on the query request, a target sub-area, a starting time, an ending time, time dimensions of the starting time and the ending time, a first unit time period associated with the ending time, and a second unit time period associated with the starting time. In some embodiments, the first unit time period may include the ending time. In some embodiments, the second unit time period may be one granularity prior to a unit time period including the starting time in each time dimension of a storage space. More descriptions of operation 1120 may be found elsewhere in the present disclosure (e.g., operation 1020 in FIG. 10 and descriptions thereof).

In 1130, the processing engine 112 (e.g., the data determination unit 601) may determine whether at least one of a first sum and a second sum is stored in a cache of the system (e.g., the data system 100). In response to a determination that the at least one of the first sum and the second sum is stored in the cache, the process 1100 may proceed to 1140. In response to a determination that the at least one of the first sum value and the second sum is not stored in the cache, the process 1100 may proceed to 1150. In 1140, the processing engine 112 (e.g., the cache data obtaining unit 602) may obtain the at least one of the first sum and the second sum from the cache. In 1150, the processing engine 112 (e.g., the storage space data obtaining unit 603) may obtain the at least one of the first sum and the second sum from the storage space.

In 1160, the processing engine 112 (e.g., the second determination module 540) may determine a query result by subtracting a second integration of the second sum in all of the time dimensions from a first integration of the first sum in all of the time dimensions, and adding a third integration of a third sum of a third set of historical data in all of the time dimensions. In some embodiments, the third set of historical data may correspond to one or more unit time periods of which historical data are subtracted repeatedly. More descriptions of operation 1160 may be found elsewhere in the present disclosure (e.g., operation 1040 in FIG. 10 and descriptions thereof).

In 1170, the processing engine 112 (e.g., the feedback module 550) may transmit the query result to the computing terminal. More descriptions of operation 1170 may be found elsewhere in the present disclosure (e.g., operation 1050 in FIG. 10 and descriptions thereof).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

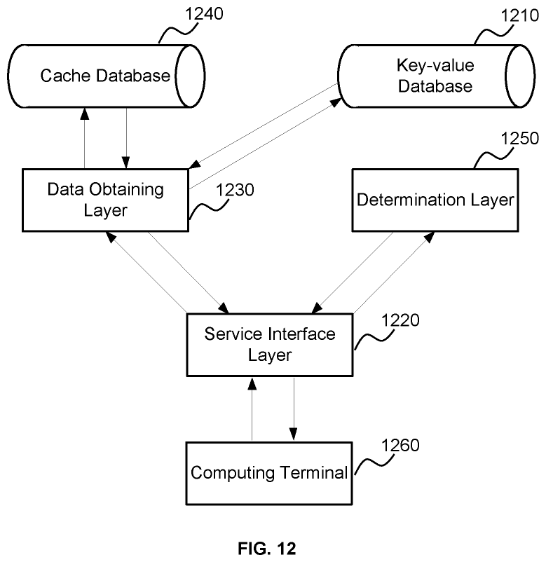

FIG. 12 is a schematic diagram illustrating an exemplary process for data query according to some embodiments of the present disclosure. In some embodiments, the storage space disclosed in the present disclosure may be a key-value database 1210. The key-value database 1210 may be used for storing, retrieving, and/or managing data. In the key-value database 1210, data may be stored and retrieved using one or more primary keys that can uniquely identify the data. In some embodiment, the key-value database 1210 may be used for storing data and querying data as described in the present disclosure. For example, primary keys of the key-value database 1210 may include a plurality of unit time periods and m time dimensions as described elsewhere in the present disclosure.

As illustrated in FIG. 12, a service interface layer 1220 may obtain a query request from a computing terminal 1260. Then the service interface layer 1220 may request a data obtaining layer 1230 to obtain data. The data obtaining layer 1230 may obtain data that used to determine a query result of the query request according to process 1000 as illustrated in FIG. 10. For example, the data obtaining layer 1230 may determine, based on the query request, a target sub-area, a starting time, an ending time, time dimensions of the starting time and the ending time, a first unit time period associated with the ending time, and a second unit time period associated with the starting time as described in connection with operation 1020. The data obtaining layer 1230 may also determine a first sum associated with the first unit time period, and a second sum associated with the second unit time period as described in connection with operation 1030. In some embodiments, the data obtaining layer 1230 may determine difference values of the first sum and the second sum in each time dimension of the storage space. In some embodiments, the data obtaining layer 1230 may determine the difference values of the first sum and the second sum in each time dimension of the storage space simultaneously.

Merely for illustration purpose, in order to determine a number (or count) of service orders in a time interval of 7:00 am˜9:30 in each day from Aug. 7, 2016 to Aug. 12, 2016 in the two dimensional storage space as illustrated in FIG. 8B, the data obtaining layer 1230 may obtain a plurality of sums associated with unit time periods labelled as “20160812” in the horizontal dimension and “0900” in the vertical dimension, labelled as “20160806” in the horizontal dimension and “0630” in the vertical dimension, labelled as “20160806” in the horizontal dimension and “0900” in the vertical dimension, and labelled as “20160812” in the horizontal dimension and “0630” in the vertical dimension as described in connection with operation 1040 and operation 1050. In some embodiments, the data obtaining layer 1230 may obtain the plurality of sums associated with these unit time periods at the same time. In some embodiments, the data obtaining layer 1230 may determine whether at least one of the sums associated with these unit time periods is stored in a cache database 1240 of the data system 100. In response to a determination that the at least one of the sums is stored in the cache database 1240, the data obtaining layer 1230 may obtain the at least one of the sums from the cache database 1240. In response to a determination that the at least one of the sums is not stored in the cache database 1240, the data obtaining layer 1230 may obtain the at least one of the sums from the key-value database 1210.

In some embodiments, after obtaining the at least one of the sums from the key-value database 1210, the data obtaining layer 1230 may store the at least one of the sums in the cache database 1240. In some embodiments, the data obtaining layer 1230 may transmit data (e.g., the sums) to the service interface layer 1220. The service interface layer 1220 may further transmit the data to a determination layer 1250 for determining the query result as described in connection with operation 1040. In some embodiments, the service interface layer 1220 may obtain the query result from the determination layer 1250. In some embodiments, the service interface layer 1220 may further transmit the query result to the computing terminal 1260.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system of data storage, comprising:
at least one storage device including a set of instructions or programs; and
at least one processor configured to communicate with the at least one storage device, wherein when executing the set of instructions or programs, the at least one processor is configured to cause the system to:
divide an area into a plurality of sub-areas;
for each sub-area of the plurality of sub-areas,
divide a time period associated with historical data of the each sub-area into a plurality of unit time periods, wherein the historical data satisfy an interval subtraction rule;
determine a relationship between each unit time period and a sum of historical data up to each unit time period; and
store a plurality of sums associated with the plurality of unit time periods into a storage space in a chronological order.

2. The system of claim 1, wherein the number n of the plurality of unit time periods for each sub-area is an integer greater than 1, and to determine the plurality of relationships, the at least one processor is further configured to cause the system to:
determine a sum of historical data from a start time of the time period to each unit time period; and
associate the sum of historical data with each unit time period.

3. The system of claim 1, wherein the storage space is an m+1 dimensional storage space, and the at least one processor is further configured to cause the system to:
determine m time dimensions other than a time dimension related to the time period, m being an integer greater than or equal to 0; and
determine the m+1 dimensional storage space based on the time dimension related to the time period and the m time dimensions.

4. The system of claim 3, wherein to determine the m+1 dimensional storage space based on the time dimension related to the unit time period and the m time dimensions, the at least one processor is further configured to cause the system to:
determine a granularity of the time dimension related to the time period of the m+1 dimensional storage space; and
determine m granularities of the m time dimensions of the m+1 dimensional storage space, respectively.

5. The system of claim 1, wherein the storage space is a key-value database, and primary keys of the key-value database include the plurality of unit time periods and the m time dimensions.

6. The system of claim 1, wherein the plurality of sub-areas have a same size.

7. The system of claim 1, wherein
each sub-area has a rectangular shape.

8. A system of data query, comprising:
at least one storage device including a set of instructions or programs;
an exchange data port communicatively connected to a network; and
at least one processor configured to communicate with the at least one storage device, wherein when executing the set of instructions or programs, the at least one processor is configured to cause the system to:
receive a query request via the data exchange port;
determine, based on the query request, a target sub-area, a starting time, and an ending time;
determine, based on historical data associated with the target sub-area, an initial time, and time dimensions related to the historical data associated with the target sub-area;
determine a first unit time period associated with the ending time;
determine a second unit time period associated with the starting time;
determine a first sum of a first set of historical data from the initial time to a unit time period prior to the first unit time period;
determine a second sum of a second set of historical data from the initial time to a unit time period prior to the second unit time period; and
determine a query result based on the first sum, the second sum, and the time dimensions related to the historical data associated with the target sub-area.

9. The system of claim 8, wherein to determine the first sum of the first set of historical data and the second sum of the second set of historical data, the at least one processor is further configured to cause the system to:
determine whether at least one of the first sum or the second sum is stored in a cache of the system.

10. The system of claim 9, the at least one processor is further configured to cause the system to:
in response to a determination that the at least one of the first sum or the second sum is stored in the cache,
obtain the at least one of the first sum or the second sum from the cache.

11. The system of claim 9, the at least one processor is further configured to cause the system to:
in response to a determination that the at least one of the first sum or the second sum is not stored in the cache,
obtain the at least one of the first sum or the second sum from a storage space.

12. The system of claim 8, wherein to determine the query result based on the first sum value, the second sum value, and the time dimensions related to the historical data associated with the target sub-area, the at least one processor is further configured to cause the system to:
subtract a second integration of the second sum in all of the time dimensions from a first integration of the first sum in all of the time dimensions; and
add a third integration of a third sum of a third set of historical data in all of the time dimensions, the third set of historical data corresponding to one or more unit time periods of which historical data are subtracted repeatedly.

13. The system of any claim 8, to receive the query request, the at least one processor is further configured to cause the system to:
receive the query request from a computing terminal via the data exchange port.

14. The system of claim 13, the at least one processor is further configured to cause the system to:
transmit the query result to the computing terminal via the data exchange port.

15. A method for storing data implemented on a computing device having one or more processors and one or more storage devices, the method comprising:
dividing an area into a plurality of sub-areas;
for each sub-area of the plurality of sub-areas,
dividing a time period associated with historical data of the each sub-area into a plurality of unit time periods, wherein the historical data satisfy an interval subtraction rule;
determining a relationship between each unit time period and a sum of historical data up to each unit time period; and
storing a plurality of sums associated with the plurality of unit time periods into a storage space in a chronological order.

16. The method of claim 15, wherein the number n of the plurality of unit time periods for each sub-area is an integer greater than 1, and determining the plurality of relationships comprises:
determining a sum of historical data from a start time of the time period to each unit time period; and
associating the sum of historical data with each unit time period.

17. The method of claim 15, wherein the storage space is an m+1 dimensional storage space, further comprising:
determining m time dimensions other than a time dimension related to the time period, m being an integer greater than or equal to 0; and
determining the m+1 dimensional storage space based on the time dimension related to the time period and the m time dimensions.

18. The method of claim 17, wherein determining the m+1 dimensional storage space based on the time dimension related to the unit time period and the m time dimensions comprises:
determining a granularity of the time dimension related to the time period of the m+1 dimensional storage space; and
determining m granularities of the m time dimensions of the m+1 dimensional storage space, respectively.

19. The method of claim 15, wherein the storage space is a key-value database, and primary keys of the key-value database include the plurality of unit time periods and the m time dimensions.

20. The method of claim 15, wherein the plurality of sub-areas have a same size.

21-30. (canceled)
